(19) United States
(12) Patent Application Publication
(10) Pub. No.: US 2016/0171138 A1
(43) Pub. Date: Jun. 16, 2016

(54) METHOD AND COMPUTER SYSTEM FOR SIMULATING OPERATION OF A PROGRAMMABLE INTEGRATED CIRCUIT

(71) Applicants: YANIV FAIS, TEL-AVIV (IL); RAFAEL MOSHE LEVY, TEL-AVIV (IL); AMIR ISRAEL SAHAR, KFAR SAVA (IL)

(72) Inventors: YANIV FAIS, TEL-AVIV (IL); RAFAEL MOSHE LEVY, TEL-AVIV (IL); AMIR ISRAEL SAHAR, KFAR SAVA (IL)

(73) Assignee: FREESCALE SEMICONDUCTOR, INC., Austin, TX (US)

(21) Appl. No.: 14/568,282

(22) Filed: Dec. 12, 2014

(51) Int. Cl. G06F 17/50

(52) U.S. Cl. CPC G06F 17/5036

(57) ABSTRACT

In a method of simulating operation of a programmable integrated circuit, a computer is operated to execute simultaneously a functional model and a timing model of the integrated circuit. Executing the functional model comprises: determining a transaction sequence which comprises one or more successive transactions of the integrated circuit and, for each transaction of said transaction sequence, updating a state of the integrated circuit in dependence of the respective transaction. Executing the timing model comprises: determining, for each of said transactions, a corresponding latency.

A data carrier carrying executable instructions for instructing a computer to carry out the method and a computer system are proposed as well.

### FIELD OF THE INVENTION

This invention relates to a method and to a computer system for simulating operation of a programmable integrated circuit and to a data carrier.

### BACKGROUND OF THE INVENTION

Designing a new hardware system is a process which typically comprises several steps. Each of these steps may use a model at another level of abstraction.

In a process known as functional verification, a register transfer level (RTL) model can be used to ensure that the logic design conforms to a certain specification. An RTL model may describe signal connections and signal flow as well as transfer functions between sequential hardware elements and components. An RTL model may be written in a hardware description language (HDL) such as Verilog or VHDL. An RTL model typically does not contain any gate timing information. The latter can, however, be critical for the actual performance a hardware system.

Gate timing information can be obtained by converting the RTL description into a gate level design which describes the logic design at a more detailed level, e.g., using a gate level model. The gate level model may represent physical components such as transistors, resistors, capacitors, and gate connections. The gate level model may be further transformed into a layout design. The layout design may serve as a reference for fabricating a chip in which the initial logic design is implemented.

Advances in fabrication technology have allowed for the creation of chip designs with an ever larger number of circuit components. A system on chip (SOC) is an integrated circuit that comprises one or more programmable hardware components, e.g., a central processing unit (CPU) or a digital signal processor (DSP), and one or more integrated peripherals. An SOC may thus comprise both software and hardware. Therefore, additional steps may be required to ensure that the SOC will operate as expected.

Today, software is often being developed before the hardware for executing the software is available. This has led to the creation of software simulators, also known as software virtual platforms. A virtual platform allows for developing embedded software intended to be executed on an SOC before the actual physical SOC is available, and even before implementing an RTL model of the SOC. A software model known as a programmer view (PV) model can be implemented on the virtual platform using a programming language such as C or C++, for example. The software model may describe the desired behaviour of the SOC at a very high level, e.g., at a very abstract level. In order to achieve a high run speed and development speed, it may beneficial for the software model to include only such details which are needed for developing the software to be embedded in the SOC. For example, a memory access may be modelled as taking place in a single clock cycle whereas a real memory access taking place in real hardware may propagate through memory subsystem blocks over many clock cycles. In other words, the software model gives only a software view.

The PV model, also known as a functional model, may be designed to reflect only functional aspects of the hardware. In other words, the functional model is a functional description of the hardware. The functional model can be developed more easily and be executed more rapidly than a full RTL implementation. It can therefore be beneficial to implement a functional model prior to a full RTL model. A functional model may be generated, for example, using transaction level modelling (TLM). In a transaction level model, hardware components may exchange information in the form of the transactions, each module having a set of behaviours which may act upon internal or neighboring block information.

While a functional model may represent the functionality of a system comprising both hardware and software, it does in general not provide any time information about the behaviour of the system. Therefore, while the functional model can be used to determine whether embedded software will execute correctly on the real SOC, it may be insufficient for determining whether the embedded software will have the required performance, e.g., whether it will run sufficiently fast.

In order to ensure that both functionality and performance requirements are met, simulations can be performed on the basis of an RTL model of the SOC or by testing the final physical SOC. However, this may require a long iterative design process.

Architectural exploration is a design process which involves another type of model, namely, a timing model, also known as performance model. Architectural exploration can be conducted before an RTL description of the hardware is available. The timing model may be designed to represent the hardware at a level which is sufficiently detailed for determining the latency of transactions in the SOC. The timing model does, however, not need to represent the full functionality of the SOC. Notably, the timing model may lack a representation of the software installed on the SOC. Instead, the timing model may be arranged to estimate the performance, e.g., the speed, of the hardware on the basis of a sequence of transactions between the various blocks of the SOC. The timing model may thus allow estimating the operating speed of the hardware without knowing the actual software of the SOC.

### SUMMARY OF THE INVENTION

The present invention provides a method and a data carrier as described in the accompanying claims.

Specific embodiments of the invention are set forth in the dependent claims. These and other aspects of the invention will be apparent from and elucidated with reference to the embodiments described hereinafter.

### BRIEF DESCRIPTION OF THE DRAWINGS

Further details, aspects and embodiments of the invention will be described, by way of example only, with reference to the drawings. Elements in the figures are illustrated for simplicity and clarity and have not necessarily been drawn to scale.

FIG. 1 schematically shows an example of an embodiment of generating a combined functional and performance model of a system on chip.

FIG. 2 schematically shows an example of an embodiment of a method of simulating operation of an SOC using a combined functional and performance model.

FIG. 3 schematically shows an example of an embodiment of a combined functional and performance model.

FIG. 4 schematically shows an example of a computer system for carrying out the method of simulating operation of the SOC.

### DETAILED DESCRIPTION OF THE PREFERRED EMBODIMENTS

A method of simulating operation of a programmable integrated circuit is proposed. The method may comprise operating a computer to execute simultaneously a functional model and a timing model of the integrated circuit. The functional model and the timing model may be executed simultaneously in the sense that operations of the functional model and operations of the timing model are carried out by the computer in an interlaced or alternating manner, or in parallel. Executing the functional model may comprise determining a transaction sequence which comprises one or more successive transactions of the integrated circuit and, for each transaction of said transaction sequence, updating a state of the integrated circuit in dependence of the respective transaction. Executing the timing model may notably comprise determining, for each of said transactions, a corresponding latency, e.g., a duration of the respective transaction. The latency may be determined on the basis of a set of latency rules, e.g., on the basis of a set of latency rules programmed in the timing model.

Executing the functional model may comprise generating a new transaction of the mentioned sequence of transactions in dependence of a current state of said integrated circuit, or in dependence of both the current state of the integrated circuit and an input event. The input event may be a real input event, or a simulated event. A real-time event may, for example, be triggered by a developer via an input device, e.g., a mouse or a keyboard.

More specifically, the method may comprise maintaining and updating a list representing the transaction sequence. The list may comprise a sequence of transactions which have already been simulated and sequence of queued transactions. The timing model may, for example, comprise, for each of the transactions, queuing the respective transaction in a transaction queue buffer. The timing model may thus be enabled to process the transactions even when they are provided to the timing model at a rate that is higher than the rate at which the timing model can process them. Execution of the functional model may be suspended in response to detecting that the transaction queue buffer is full. Execution of the functional model may resume, for example, in response to detecting that a fill level of the transaction queue buffer has fallen below a pre-defined critical fill level.

The invention may also be implemented in a data carrier carrying executable instructions for instructing a computer to carry out the method.

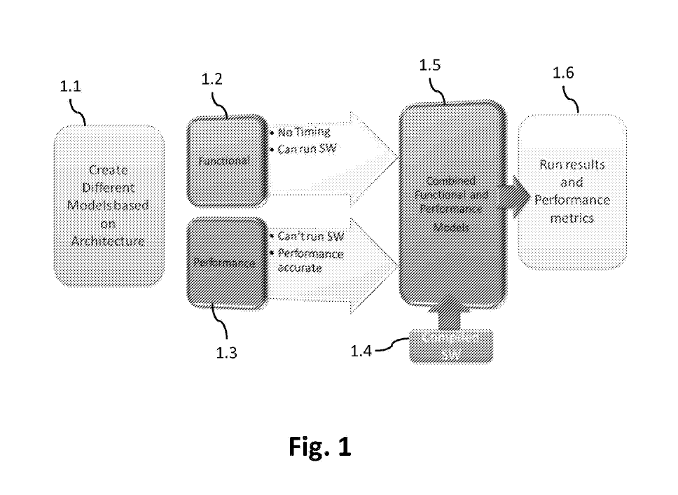

FIG. 1 schematically illustrates an example of a method of simulating operation of a programmable integrated circuit, e.g., a system on chip (SOC). The programmable integrated circuit may comprise a program, e.g., an operating system, and be arranged to execute the program. The integrated circuit that is simulated may be referred to as the model system.

In a first, preparatory action 1.1, two or more models of the integrated circuit are created. The expression “model” as used in the present context is a representation of the integrated circuit in question. As discussed above, different models of the same system may vary in the level of detail with which they describe the integrated circuit. The two or more models may notably include a programmer view (PV) model 1.2, e.g. a functional model and a timing model 1.3, e.g. a performance model. The functional model may be arranged to simulate execution of a program by the integrated circuit. However, it may be incapable of providing timing information associated with the various operations performed by the integrated circuit that is being simulated. The timing model, in contrast, may be arranged to provide timing information associated with hardware operations of the model system.

For example, the timing model may be arranged to determine, for a given transaction, a corresponding duration or latency. The timing model 1.3 may, however, be incapable of simulating the execution of software by the model system. The functional model 1.2 and the timing model 1.3 may be combined in a combined functional and timing model 1.5. Using the software installed on the model system as input data 1.4, the combined functional and timing model 1.5 may be executed on a computer simultaneously to generate run results along with timing data (1.6). Depending on the design of the functional model, the run results may indicate the complete state evolution of the model system, or may include only certain aspects of the state evolution, such as output data or transactions. The timing data may for instance be represented by one or more performance matrices.

A functional model and a timing model may thus be combined to provide a combined model which is capable of running the software on the model system and of providing related latency information at the same time. This may enable developers to develop the software in parallel with the development of the hardware architecture prior to an RTL implementation.

Furthermore, the combined model may have a higher simulation speed than an RTL model. Developers may thus be enabled to investigate alternative architectures and to analyze and fix problems in hardware architecture well in advance of emulation of an RTL model.

The combined functional and performance model may comprise a wrapping logic in which the functional model and the timing model may be embedded. The wrapping logic may be arranged in particular to handle any transactions that occur in the simulation. The transactions may be stored in an ordered list referred to as a transactions data collection. The transaction data collection may be arranged, for example, to store the following data associated with a transaction: A time of arrival, a time of issue, a source module, a target module, a transaction description, and an identifier, e.g., a pointer, which identifies an original incoming transaction. The transaction description may include, for instance, a transaction type such as read or write, and an address of a memory cell targeted by the respective transaction.

The wrapping logic may be arranged to process the transactions held in the transaction data collection on the basis of issue times associated with the transactions. The issue time of a transaction is a time at which the transaction is issued toward a target module, e.g., toward a memory unit. More specifically, the issue time of a transaction that enters a module may be set to its arrival time. The wrapping logic may be arranged to route an incoming transaction to both the functional model and the timing model.

For instance, the transaction may be sent immediately to the functional model and be processed immediately, e.g. with latency that may be substantially zero, by the functional model. The functional model may generate a result for the respective transaction. The result of a transaction may comprise in the data that is transferred by the transaction in question, e.g., the data that is written to a memory address targeted by the transaction. The result may be saved for later return, e.g., upon completion of the timing transaction.

In addition, the wrapping logic may be arranged to send the incoming transaction to the timing model. The timing model may comprise a set of behaviours and be arranged to determine a latency of the transaction on the basis of the set of behaviours. For example, a transaction may have a fixed predefined latency assigned to it. Alternatively, the latency may be evaluated by sending the transaction to additional performance modules of submodules.

Each of the functional model and the timing model may be arranged to issue transactions to external modules. The resulting transactions may be inserted into the transaction data collection and be sent to the relevant external modules based on their issue time, for example. Generally, a transaction is a transfer of information between two neighboring modules.

The functional model may be arranged to generate a transaction result for an incoming transaction. An incoming transaction may be referred to as a primary transaction. The timing model may be arranged to determine none, one, or more secondary transactions triggered by the primary transaction. Secondary transactions may include transactions to hardware blocks that are not represented in the functional model. More specifically, an incoming transaction may initiate transactions to neighboring blocks. Furthermore, the timing model may split the incoming transaction into multiple inner or external transactions. The timing model may be arranged to determine a completion time for the incoming transaction once all transactions originating from the incoming transaction within the timing model have been completed.

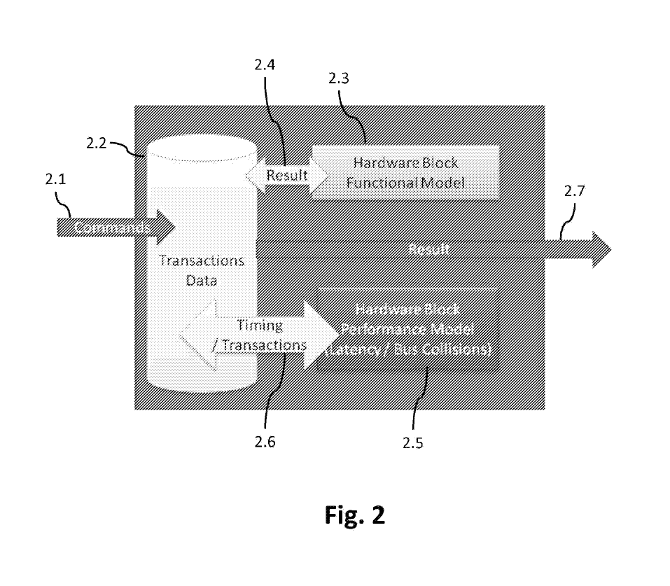

The flow chart in FIG. 2 schematically illustrates an example of a method of operating a combined functional and timing model. The method may comprise simulating the following operations, for example: receiving a sequence of commands (2.1) and updating a transaction data collection (2.2) on the basis of these commands; processing transactions from the transaction data collection by a functional model (2.3) and generating a result for each transaction (2.4). Furthermore, each transaction (2.6) from the transaction data collection may be processed by a timing model (2.5). The timing model may determine a latency, e.g., a duration, for each transaction received from the transaction data collection. Depending on the implementation, the timing model may provide additional performance information associated with the transactions. For instance, the timing model may be arranged to detect BUS collisions.

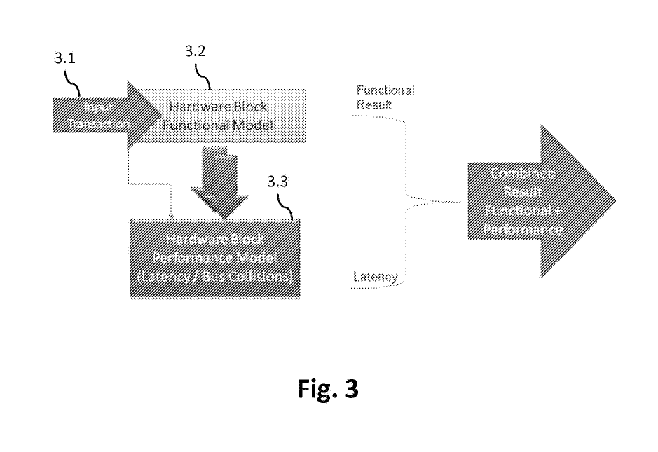

The example of a method described above in reference to FIG. 2 is further illustrated by the flowchart in FIG. 3. In the example, an input transaction (3.1) targeted at a certain hardware block that is simulated is fed to a functional model (3.2) of the respective hardware block. The functional model produces a functional result on the basis of the input transaction. The same input transaction is also fed to a timing model (3.3). The timing model determines a latency of the transaction. The functional result and the latency may be combined in a single data item for facilitating further processing or evaluation.

In one example, an integrated circuit with a functional unit or module that processes two commands is simulated. In the example, the first command is identified by a key 0xAB and the second command by a key 0xCD. In the simulation, the functional unit may perform, for example, the following operations in response to the first command with key 0xAB: get a command description from an address 0xAB (BUS A); based on a descriptor, get command data from an address 0x1000 (BUS B); and write a result to an address 0xAB+0x10. Similarly, the functional unit may perform, for example, the following operations in response to the second command with key 0xCD: get a command description from an address 0xCD (BUS A); based on a descriptor, get command data from an address 0x2000 (BUS B); and write a result to an address 0xCD +0x10. The above listed operations triggered by the two commands do, however, not include any timing information. Each operation may be annotated with a respective timing by means of the timing model. To this end, each operation, e.g., either an input transaction or a transaction from the functional model, may be indicated to the timing model, e.g., as schematically illustrated in FIG. 2. The various operations, e.g., transactions, may be processed in an interleaved manner. For instance, the operations A1 to A3 and B1 to B3 may be processed in the following chronological order: 10 nanoseconds (ns)-A1; 12 ns-A2; 14 ns-B1; 24 ns-B2; 36 ns-B3; 42 ns-A3, wherein each instant (e.g., 10 ns) indicates the start time of the respective operations (e.g., A1).

The combined model may be implemented, for example, using software which incorporates the timing and functional view models as well as logic for maintaining the operations of the simulated hardware and the respective timing and functional result of each operation. In addition, the logic may be arranged to maintain modules in communication with the combined model. The functional model and the timing model may, for example, be instantiated in a virtual platform.

Operation of the functional model may be independent of operation of the timing model. In contrast, the timing model may depend, albeit loosely, on the functional model. More specifically, commands may be sent to the functional model for processing, e.g., for immediate processing, and may be stored at the same time in the timing model. In the functional model a given command may produce read data calls and write data calls, e.g., to external memory. The external memory may respond immediately to these calls. In parallel, the calls may be translated to timing transactions in the timing model. These timing transactions are associated with the original command. Processing of the command may be considered as completed once the processing of the timing transactions has been completed. This may take one or more clock cycles, e.g., two hundred clock cycles. In the meantime, additional commands may be processed by the functional and the performance models. In other words, calls to external memory may be communicated from the functional model to the timing model, and the timing model may translate the calls into timing transactions. Thus, the timing model may be provided with information from the functional model, namely with the calls to external memory, for instance.

Conversely, the timing model may also affect the behaviour of the functional model, albeit only in an indirect manner. Namely, commands which are currently being processed may be held in one or more buffers. If these buffers are full, a new command cannot be issued to the functional model until space becomes available in the buffers. Buffer space may become available upon completion of a command.

The invention may notably be implemented in a computer program for running on a computer system, at least including code portions for performing steps of a method according to the invention when run on a programmable apparatus, such as a computer system or enabling a programmable apparatus to perform functions of a device or system according to the invention.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on computer readable storage medium or transmitted to the computer system via a computer readable transmission medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; non-volatile memory storage media including semiconductor-based memory units such as FLASH memory, EEPROM, EPROM, ROM; ferromagnetic digital memories; MRAM; volatile storage media including registers, buffers or caches, main memory, RAM, etc.; and data transmission media including computer networks, point-to-point telecommunication equipment, and carrier wave transmission media, just to name a few.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

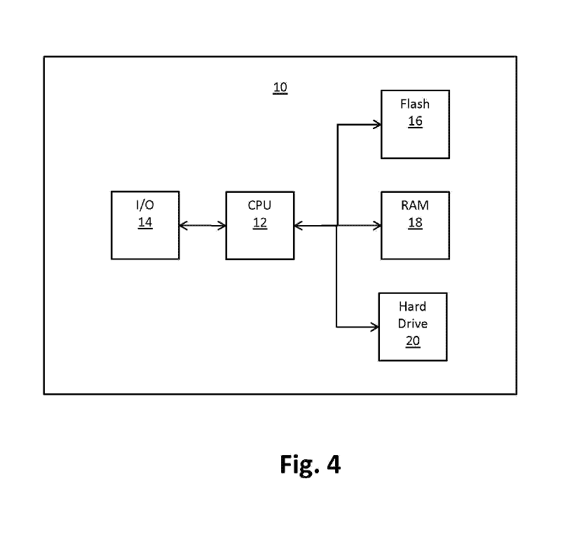

An example of a computer system for carrying out the simulation method described above in reference to FIGS. 1, 2, and 3 is schematically illustrated in FIG. 4. The computer system 10 may include, for example, a central processing unit (CPU) 12 for carrying out executable code residing within the computer system 10, e.g., on one or more memory units 16, 18, 20. The memory units may include, for example, one or more of a flash memory unit 16, a random access memory unit 18, and a magnetic storage unit 20. The executable code may include, among others, a program for instructing the CPU 12 to simulate operation of the programmable integrated circuit. The computer system 10 may also comprise a user interface 14 for enabling a user to interact with the computer system 10, e.g., to configure the computer system 10 to simulate operation of the integrated circuit. The units 12 to 20 and any other units (not shown) may be connected among each other by suitable signal lines or data buses. The transaction queue buffer may be located, for example, on one of the memory units 16, 18, 20, or in the CPU, or distributed across several physical or logical units.

In the foregoing specification, the invention has been described with reference to specific examples of embodiments of the invention. It will, however, be evident that various modifications and changes may be made therein without departing from the broader spirit and scope of the invention as set forth in the appended claims.

For example, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

1. A method of simulating operation of a programmable integrated circuit, comprising:
operating a computer to execute simultaneously a functional model and a timing model of the integrated circuit;
wherein the act of executing the functional model comprises:
determining a transaction sequence which comprises one or more successive transactions of the integrated circuit and, for each transaction of said transaction sequence, updating a state of the integrated circuit in dependence of the respective transaction;
and wherein the act of executing the timing model comprises:
determining, for each of said transactions, a corresponding latency.

2. The method of claim 1, wherein said act of executing the functional model comprises:
generating a new transaction of said sequence of transactions in dependence of a current state of said integrated circuit.

3. The method of claim 1, wherein said act of executing the functional model comprises:
generating a new transaction of said transaction sequence in dependence of a current state of the integrated circuit and an input event. .

4. The method of claim 1, comprising:
maintaining and updating a list representing said transaction sequence.

5. The method of claim 1, wherein executing the timing model comprises, for each of said transactions:
queuing the respective transaction in a transaction queue buffer.

6. The method of claim 5, comprising:
suspending execution of the functional model in response to detecting that said transaction queue buffer is full.

7. The method of claim 1, wherein said act of determining a corresponding latency is performed on the basis of a set of latency rules.

8. A data carrier carrying executable instructions for instructing a computer to carry out the method of claim 1.

9. A computer system arranged to carry out the method of claim 1.
